(19) United States
(12) Patent Application Publication
(10) Pub. No.: US 2004/0012344 A1
(43) Pub. Date: Jan. 22, 2004

(54) Lamp with integral universal USB ports for connecting computers and other peripherals

(75) Inventor: Lawrence Bibi, Jersey City, NJ (US)

Correspondence Address: EZRA SUTTON, P.A., PLAZA 9, 900 ROUTE 9, WOODBRIDGE, NJ, 07095, US

(73) Assignee: Checkolite International, Inc.

(21) Appl. No.: 10/199,834

(22) Filed: Jul. 22, 2002

(51) Int. Cl. H05B 39/04

(52) U.S. Cl. 315/291; 315/294; 315/292; 315/362

(57) ABSTRACT

The present invention provides for a lamp having USB ports for connecting computer peripheral devices to the lamp which is connected to a computer. The lamp has a circuit which includes the plurality of USB ports for connection with a plurality of computer peripheral devices. A computer having a USB port is connected to the lamp circuit in order to connect the computer peripherals through the lamp circuit to the computer.

### FIELD OF INVENTION

The present invention relates to a lamp with integral Universal Serial Bus (USB) ports for connecting a computer with other peripheral devices.

### BACKGROUND OF THE INVENTION

As technology in the computing field has advanced, there has arisen an increasing need to modify or customize one's personal computer with peripheral devices reflective of these technical advances. In order to accommodate these peripheral devices may personal computers contain Universal Serial Bus (USB) ports in which such devices can be plugged into. However, these USB ports are often located on the back of the Central Processing Unit (CPU) where there is limited space to accommodate such ports. In addition, because of the numerous peripheral devices linked to computers, workspace locations often become congested and cluttered with such devices such as computer lamps, printers or joysticks. This greatly reduces available workspace for performing other duties. There is a need for an ergonomic USB port expansion device which can not only expand greatly the number of available USB ports for use with peripheral devices, but which can also provide a separate function such as acting as a computer lamp.

It is an object of the present invention to provide for an ergonomic lamp having USB expansion port capabilities.

It is a further object of the present invention to provide for a lamp having USB expansion ports which can greatly reduce the cluster and entanglement of USB wires connecting computer peripheral devices.

It is a further object of the present invention to provide for a lamp having USB expansion ports which can not only illuminate one's computer workstation, but can greatly expand the freedom of use of such peripheral devices.

### DESCRIPTION OF PRIOR ART

U.S. Pat. No. 6,044,428 discloses a Universal Serial Bus node having a non-volatile memory preprogrammed with the data bits necessary to configure an attached machine to become a translator or modified translator for signals from a computer peripheral device. On startup, the Universal Serial Bus node is configured to translate signals to and from the computer peripheral device into USB protocol signals to and from a Universal Serial Bus equipped computer in order to assure proper communication therebetween.

U.S. Pat. No. 6,246,212 discloses a function extending apparatus detachably connected to an electronic apparatus to enhance functions of the electronic apparatus, the function extending apparatus including a connection between a battery and a charging part in accordance with the result of detection of docking to the electronic apparatus so as to supply power from the electronic apparatus to the battery.

### SUMMARY OF THE INVENTION

The present invention provides for a lamp having USB ports for connecting computer peripheral devices to the lamp which is connected to a computer. The invention includes a lamp having a circuit which includes a plurality of USB ports for connection with a plurality of computer peripheral devices. A computer having a USB port is connected to the aforementioned lamp circuit in order to connect the computer peripherals through the lamp circuit to the computer.

### BRIEF DESCRIPTION OF THE DRAWINGS

FIG. 1 is a perspective view of lamp 10 having USB ports for connecting to computer peripheral devices;

FIG. 2 is a perspective view of the circuit 30 of lamp 10 having USB ports;

FIG. 3 is a perspective view of lamp 10 having USB ports for connecting computer peripheral devices to the lamp and accordingly to a computer;

FIG. 4 is a cross sectional view of lamp 10 having USB ports for connecting to computer peripheral devices; and

FIG. 5 is a perspective view of the circuit 100 of lamp 10 having USB ports.

### DETAILED DESCRIPTION OF THE PREFERRED EMBODIMENTS

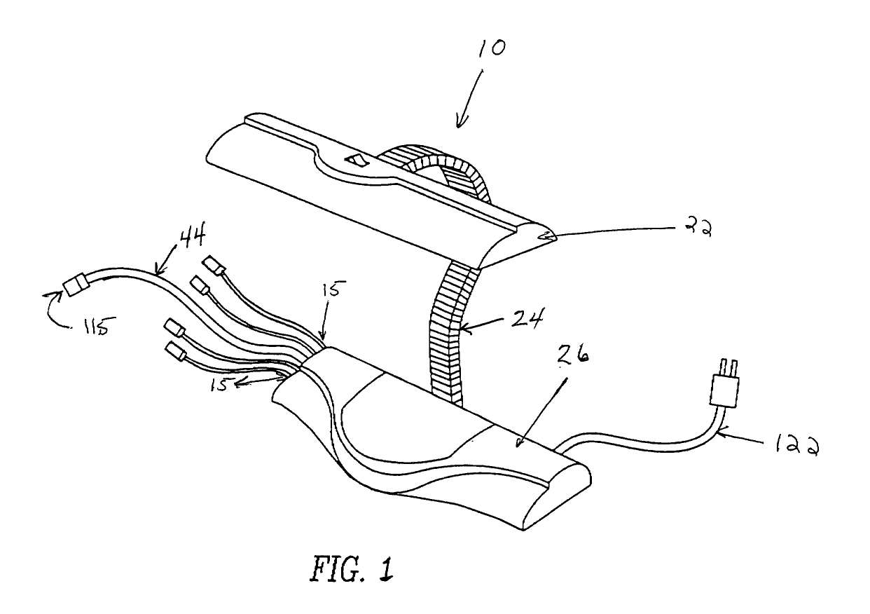

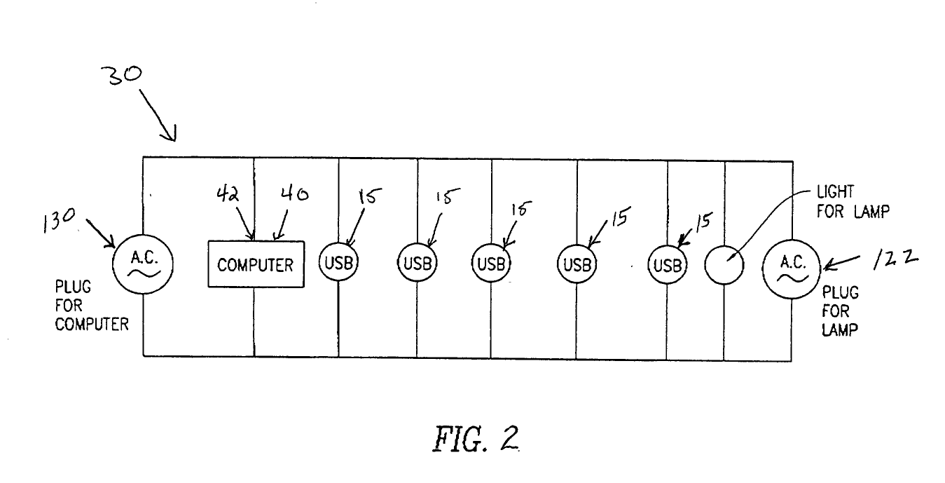

FIGS. 1 through 4 show lamp 10 having USB ports 15 for connecting computer peripheral devices to lamp 10. Lamp 10 includes a lamp 22 and a neck 24 having a circuit 30 (as shown in FIG. 2) which includes a plurality of USB ports 15 in parallel for connecting a plurality of computer peripheral devices to the ports 15. Lamp 10 also includes a plug 122 for connection to an A.C. outlet. A computer 40 having a USB port 42 is connected by line 44 to lamp circuit 30 in order to connect the computer peripheral devices 50, 60 through lamp circuit 30 to the computer 40. Computer 40 also includes a plug 130 for connection to an A.C. outlet.

Lamp circuit 30 includes at least four (4) USB ports 15 connected in parallel, but the number may vary. In addition, lamp circuit 30 and USB ports 15 are located in the base 26 of lamp 10.

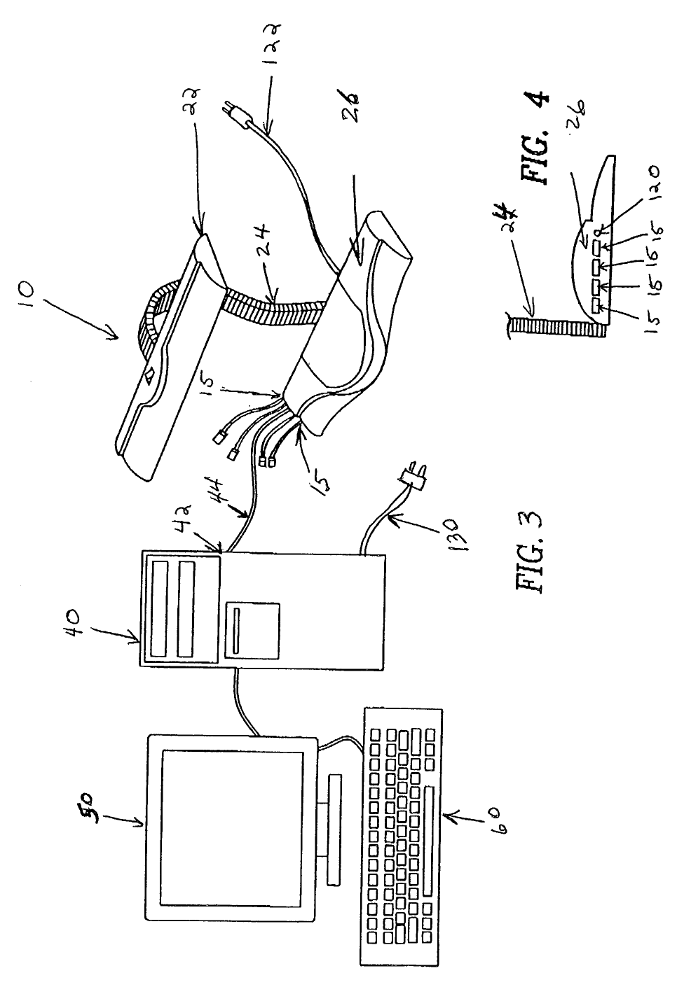

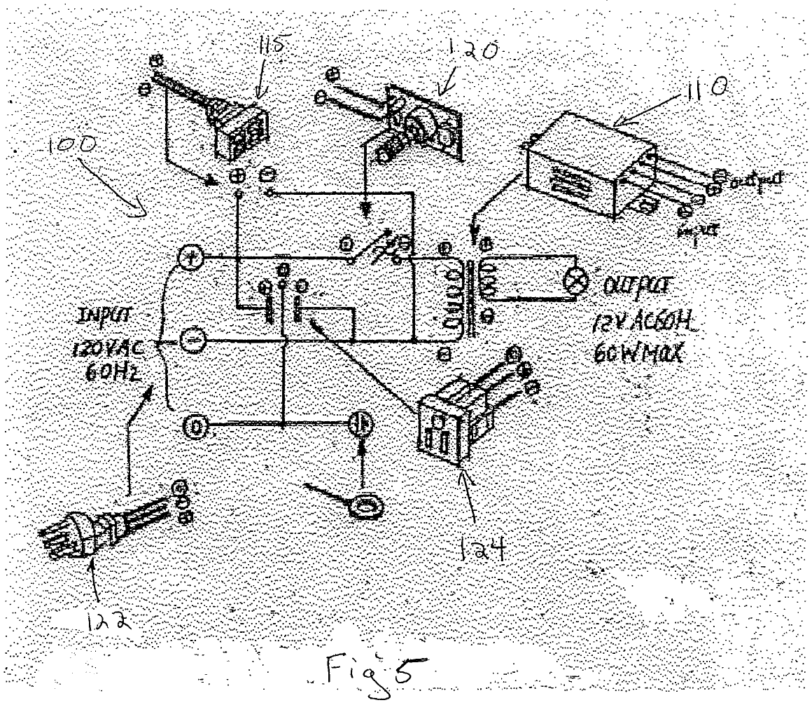

FIG. 5 shows lamp circuit 100 which includes a transformer box 110 with an output of 12V/60 W maximum, USB plug 115 (as also seen in FIG. 1), lamp switch 120 (as also seen in FIG. 4), and a three pronged plug 122 (as also seen in FIGS. 1 and 3) with an input of 120V for inserting into outlet 124.

Lamp 10's USB ports 15 can be used to connect such peripheral devices as monitors 50, keyboards 60, mice, game devices, audio IO devices, telephones, modems, CD-ROM or DVD drives, joysticks, tape and floppy disk drives, and imaging devices such as scanners and printers. This list is by way of example only.

### ADVANTAGES OF THE PRESENT INVENTION

It is an advantage of the present invention to provide for an ergonomic lamp having USB expansion port capabilities.

It is a further advantage of the present invention to provide for a lamp having USB expansion ports which can greatly reduce the cluster and entanglement of USB wires connecting computer peripheral devices.

It is a further advantage of the present invention to provide for a lamp having USB expansion ports which can not only illuminate one's computer workstation, but can greatly expand the freedom of use of such peripheral devices.

A latitude of modification, change, and substitution is intended in the foregoing disclosure, and in some instances, some features of the invention will be employed without a corresponding use of other features. Accordingly, it is appropriate that the appended claims be construed broadly an in a manner consistent with the spirit and scope of the invention herein.

What is claimed is:

1. A lamp having USB ports for connecting computer peripheral devices to said lamp which is connected to a computer, comprising:
a) a lamp having a circuit which includes a plurality of USB ports for connecting thereto a plurality of computer peripheral devices; and
b) a computer having a USB port connected to said lamp circuit for connecting said computer peripherals through said lamp circuit to said computer.

2. A lamp having USB ports in accordance with claim 1, wherein said computer peripheral devices are selected from the group consisting of monitors, keyboards, mice, game devices, audio IO devices, telephones, modems, CD-ROM or DVD drives, joysticks, tape and floppy disk drives, and imaging devices such as scanners and printers.

3. A lamp having USB ports in accordance with claim 1, wherein said lamp circuit includes at least four (4) USB ports connected in parallel, and said USB ports and said lamp circuit are located in the base of said lamp.
